(19) United States
(12) Patent Application Publication
(10) Pub. No.: US 2026/0087842 A1
(43) Pub. Date: Mar. 26, 2026

(54) INFORMATION PROCESSING SYSTEM, INFORMATION PROCESSING METHOD, AND RECORDING MEDIUM IN WHICH INFORMATION PROCESSING PROGRAM IS RECORDED

(71) Applicant: Sharp Kabushiki Kaisha, Sakai City (JP)

(72) Inventor: Hideki OHNISHI, Sakai City (JP)

(21) Appl. No.: 19/327,170

(22) Filed: Sep. 12, 2025

(30) Foreign Application Priority Data
Sep. 24, 2024 (JP) 2024-165158

(51) Int. Cl. G06V 30/414; G06V 10/98; G06V 30/12; G06V 30/26

(52) U.S. Cl. CPC G06V 30/414; G06V 10/98; G06V 30/12; G06V 30/26

(57) ABSTRACT

An image processing apparatus includes an extraction processing unit that extracts text information and an image object regarding an extraction target item of document data, a calculation processing unit that calculates a first accuracy level of the text information and a second accuracy level of the image object, regarding an accuracy level representing a confidence level of the extraction target item, a correction processing unit that corrects the first accuracy level when a first character string rectangle of the text information and a second character string rectangle of the image object overlap each other, and an output processing unit that outputs a candidate character string of the extraction target item based on the corrected first accuracy.

### INCORPORATION BY REFERENCE

This application is based upon and claims the benefit of priority from the corresponding Japanese Patent Application No. 2024-165158 filed on Sep. 24, 2024, the entire contents of which are incorporated herein by reference.

### BACKGROUND

The disclosure relates to a technique for performing image processing such as character recognition on an input image.

Techniques for performing character recognition (OCR processing) on data written on documents such as forms are known in the related art. For example, there is known a technique of determining whether to perform optical character recognition processing on an electronic document based on whether document data is an electronic document generated by an application program with text information held or an electronic document generated by reading an image by a document reading device (such as a scanner).

Here, for example, a document generated by an application program may include a text object (embedded text) and an image object. In this case, characters (embedded text) recognized from the text object are not always correct, and a method of uniformly extracting the embedded text causes a problem of a decrease in character recognition accuracy.

### SUMMARY

An object of the disclosure is to provide an information processing system, an information processing method, and a recording medium in which an information processing program is recorded that are capable of improving character recognition accuracy for document data including a text object being embedded text and an image object.

According to an aspect of the disclosure, an information processing system includes an extraction processing unit, a calculation processing unit, a correction processing unit, and an output processing unit. The extraction processing unit extracts text information and an image object, regarding an extraction target item of document data. The calculation processing unit calculates a first accuracy level of the text information and a second accuracy level of the image object, regarding an accuracy level representing a confidence level of the extraction target item. The correction processing unit corrects the first accuracy level when a first character string rectangle of the text information and a second character string rectangle of the image object overlap each other. The output processing unit outputs a candidate character string of the extraction target item based on the first accuracy level corrected by the correction processing unit.

According to another aspect of the disclosure, an information processing method is executed by one or more processors, and the information processing method includes extracting text information and an image object regarding an extraction target item of document data, calculating a first accuracy level of the text information and a second accuracy level of the image object regarding an accuracy level representing a confidence level of the extraction target item, correcting the first accuracy level when a first character string rectangle of the text information and a second character string rectangle of the image object overlap each other, and outputting a candidate character string of the extraction target item based on the corrected first accuracy level.

According to still another aspect of the disclosure, a recording medium is recorded with a program that causes one or more processors to execute extracting text information and an image object regarding an extraction target item of document data, calculating a first accuracy level of the text information and a second accuracy level of the image object regarding an accuracy level representing a confidence level of the extraction target item, correcting the first accuracy level when a first character string rectangle of the text information and a second character string rectangle of the image object overlap each other, and outputting a candidate character string of the extraction target item based on the corrected first accuracy level.

According to the disclosure, an information processing system, an information processing method, and a recording medium in which an information processing program is recorded can be provided that are capable of improving character recognition accuracy for document data including a text object being embedded text and an image object.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a function block diagram illustrating a configuration of an image processing system according to an embodiment of the disclosure.

FIG. 2 is a diagram illustrating one example of a document (PDF file) according to the embodiment of the disclosure.

FIG. 3 is a flowchart illustrating an example of the procedure of character extraction processing that is performed in an image processing apparatus according to the embodiment of the disclosure.

FIG. 4 is a flowchart illustrating an example of the procedure of character extraction processing that is performed in the image processing apparatus according to the embodiment of the disclosure.

FIG. 5 is a diagram illustrating a specific example of a confidence level that is calculated in the image processing apparatus according to the embodiment of the disclosure.

FIG. 6 is a diagram illustrating a specific example of a confidence level that is calculated in the image processing apparatus according to the embodiment of the disclosure.

FIG. 7 is a diagram illustrating a specific example of a confidence level that is calculated in the image processing apparatus according to the embodiment of the disclosure.

FIG. 8 is a diagram illustrating a display example of character string information in the image processing apparatus according to the embodiment of the disclosure.

FIG. 9 is a diagram illustrating a display example of character string information in the image processing apparatus according to the embodiment of the disclosure.

FIG. 10 is a flowchart illustrating another example of the procedure of character extraction processing that is performed in the image processing apparatus according to the embodiment of the disclosure.

FIG. 11 is a flowchart illustrating another example of the procedure of character extraction processing that is performed in the image processing apparatus according to the embodiment of the disclosure.

### DETAILED DESCRIPTION

Embodiments of the disclosure will be described below with reference to the drawings. Note that the following embodiments are specific examples of the disclosure, and do not limit the technical scope of the disclosure.

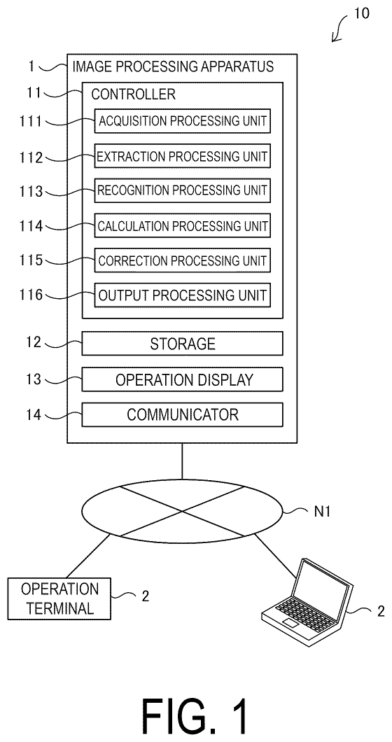

FIG. 1 is a block diagram illustrating a configuration of an image processing system 10 according to an embodiment of the disclosure. The image processing system 10 includes an image processing apparatus 1 and an operation terminal 2. The image processing apparatus 1 and the operation terminal 2 are connected to each other via a network N1 (for example, the Internet, a LAN, or the like). The image processing system 10 may include a plurality of operation terminals 2.

In the image processing system 10, the image processing apparatus 1 acquires document data (image data) such as a form transmitted from the operation terminal 2 and extracts a desired character string (character string to be managed) from the document data. For example, the operation terminal 2 transmits document data (such as a PDF file) generated by scanning a paper form such as an invoice, a quotation, a delivery note, a purchase order, a receipt, a sales receipt, and other documents to the image processing apparatus 1. Further, the operation terminal 2 creates a document file of the form based on a user operation by, for example, a document creation application or the like, and transmits the document file as image data (for example, searchable PDF data (image and text data), or the like) to the image processing apparatus 1. When the image processing apparatus 1 receives the document data transmitted from the operation terminal 2, the image processing apparatus 1 performs various types of processing, which will be described below, on the document data to extract a character string of a management target (extraction target item) included in the form. For example, the image processing apparatus 1 extracts a classification (type) for each of the forms, a date for each of the forms, an amount of money (total amount of money, or the like), company information (an issuer, a destination, a registration number, or the like), and the like. Further, the image processing apparatus 1 registers the extracted character string in a predetermined database. For example, every time the image processing apparatus 1 acquires image data of an invoice, the image processing apparatus 1 extracts character strings related to the content of the invoice (for example, an issue date, an invoice amount, an issuer, and the like) from the image data and registers the extracted character strings in a database that manages invoices. In addition, each time the image processing apparatus 1 acquires image data of a sales receipt, the image processing apparatus 1 extracts character strings related to the content of the sales receipt (for example, an issue date, a total amount, an issuer, and the like) from the image data and registers the extracted character strings in a database that manages sales receipts. This enables each form to be stored and managed as electronic data. Additionally, the image processing apparatus 1 outputs the extracted character strings to the operation terminal 2 or the like and presents the character recognition result to the user.

The image processing system 10 is an example of an information processing system according to the disclosure. Note that the information processing system according to the disclosure may be constituted by the image processing apparatus 1 alone.

### Image Processing Apparatus 1

As illustrated in FIG. 1, the image processing apparatus 1 includes a controller 11, a storage 12, an operation display 13, a communicator 14, and the like. The image processing apparatus 1 may be one or more cloud servers or one or more physical servers.

The communicator 14 is a communication interface for connecting the image processing apparatus 1 to the network N1 in a wired or wireless manner and executing data communication with the operation terminal 2 via the network N1 in accordance with a predetermined communication protocol. The network N1 includes, for example, the Internet, a LAN, or the like.

The operation display 13 is a user interface including a display such as a liquid crystal display or an organic EL display that displays various types of information, and an operation inputter such as a mouse, a keyboard, or a touch panel that receives an operation.

The storage 12 is a non-volatile storage, such as a Hard Disk Drive (HDD), a Solid State Drive (SSD), or flash memory, that stores various types of information. The storage 12 stores a control program that causes the controller 11 to perform character extraction processing, which will be described below. For example, the control program is non-transiently recorded in a computer-readable recording medium such as a CD or a DVD, read by a reading device (not illustrated) such as a CD drive or a DVD drive included in the image processing apparatus 1, and stored in the storage 12. Note that the control program may be distributed from a cloud server and stored in the storage 12.

The storage 12 also stores document data (a PDF file or the like) of a form or the like acquired from the operation terminal 2.

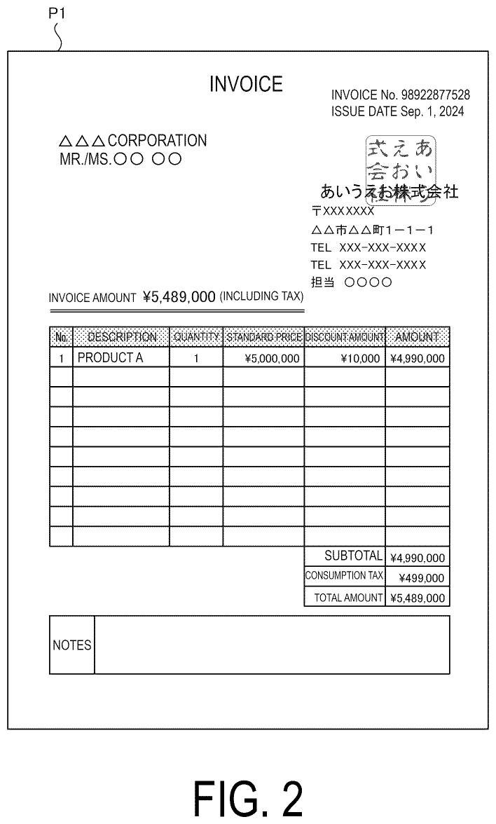

FIG. 2 illustrates an invoice as an example of a form (document data P1). As illustrated in FIG. 2, the invoice includes character strings such as a document classification (“invoice”), an issue date, contact information of an issuer (an address, a telephone number, a FAX number, a person in charge), an invoice amount, a product name, a quantity, a standard price, a discount amount, a subtotal, a consumption tax, and a total amount. For example, the user uploads, to the image processing apparatus 1, the document data P1 (PDF file) obtained by imaging a document created by using a document creation application (that is, converting the document into PDF) in the operation terminal 2. When acquiring the document data P1 of the invoice, the controller 11 stores the document data P1 in the storage 12. The document data P1 in FIG. 2 is data obtained by imaging the document created by the document creation application (creating the document as a PDF file), and includes text information (character data, embedded text) and image objects (character images and a seal impression image, and the like). Note that in the following description, the text information of the document data P1 is also referred to as embedded text.

As another embodiment, the controller 11 may acquire a document file of a form created in the operation terminal 2 and store the document file in the storage 12.

The controller 11 includes control devices such as a CPU, a ROM, and a RAM. The CPU is a processor that performs various types of arithmetic processing. The ROM stores in advance control programs such as a BIOS and an OS that cause the CPU to perform various types of processing. The RAM stores various types of information and is used as a temporary storage memory (work area) for the various types of processing performed by the CPU. The controller 11 controls the image processing apparatus 1 by causing the CPU to execute various types of the control programs stored in advance in the ROM or the storage 12.

The controller 11 includes various processing units such as an acquisition processing unit 111, an extraction processing unit 112, a recognition processing unit 113, a calculation processing unit 114, a correction processing unit 115, and an output processing unit 116 as illustrated in FIG. 1. Note that the controller 11 functions as the various processing units by performing various types of processing in accordance with the control programs. Further, one or some, or all of the processing units included in the controller 11 may be constituted by an electronic circuit. Note that the control program may be a program that causes a plurality of processors to function as the various types of processing units.

The acquisition processing unit 111 acquires document data (a document file). Specifically, the acquisition processing unit 111 acquires document data (a PDF file, an image file, or the like) from the operation terminal 2. The acquisition processing unit 111 acquires document data (an image file) generated by scanning a paper form with an image forming apparatus (scanner or the like).

The extraction processing unit 112 extracts a character string rectangle from the document data. Further, when the document data includes embedded text and an image object, the extraction processing unit 112 extracts a character string rectangle (first character string rectangle) of the embedded text and a character string rectangle (second character string rectangle) of the image object.

The recognition processing unit 113 performs character recognition processing on the image object. The character recognition processing includes OCR pre-processing, OCR processing, and OCR post-processing. For example, the recognition processing unit 113 performs processing such as vertical orientation correction, skew correction, background removal, and seal impression removal in the OCR pre-processing. In addition, the recognition processing unit 113 recognizes characters and identifies the position and size of a character string rectangle in the OCR processing. Further, in the OCR post-processing, the recognition processing unit 113 performs size adjustment of the character string rectangle (the corrected second character string rectangle), character correction (correction of a character based on relevance to character information before and after the character), and the like. Note that known techniques can be applied to the character recognition processing.

The calculation processing unit 114 calculates, for a recognized character, a confidence level (accuracy level, score) representing a likelihood of the extraction target item based on a recognized content, the position of the character, and relationships between the character and the surrounding characters around the character. The calculation processing unit 114 calculates the confidence level of a character string for each character string rectangle. Additionally, the calculation processing unit 114 calculates the confidence level (second confidence level and second accuracy level) of the character string recognized by OCR processing regarding the second character string rectangle of the image object and the confidence level (first confidence level and first accuracy level) of the character string recognized regarding the first character string rectangle of the embedded text. Further, the calculation processing unit 114 outputs character string information including character information, the position of a character, the size of a character string rectangle, and the confidence level of the character. The size of the character string rectangle may be represented by a height and a width, or the position of a character may be represented by coordinates of a start point (at the upper left) and an end point (at the lower right).

The correction processing unit 115 corrects the first confidence level corresponding to the character string of the first character string rectangle when the first character string rectangle and the second character string rectangle overlap each other. Specifically, the correction processing unit 115 corrects the first confidence level to a value larger than the second confidence level. In addition, the correction processing unit 115 may correct the first confidence level when an area occupancy rate of the image object in the document data is less than a threshold value.

The output processing unit 116 outputs the character string information. The output processing unit 116 outputs the candidate character string of the extraction target item based on the first confidence level corrected by the correction processing unit 115. For example, the output processing unit 116 displays a plurality of pieces of character string information aligned in a descending order of confidence levels. Further, the output processing unit 116 displays the extraction result of necessary items. The specific processing contents of the respective processing units will be described below.

### Character Extraction Processing

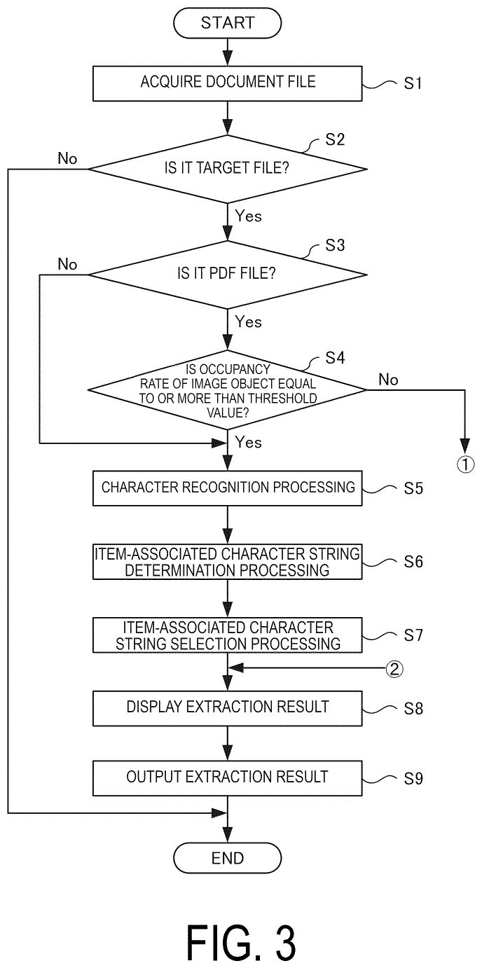

In the character extraction processing, when acquiring the document data P1 (document file), the controller 11 extracts text information and an image object regarding an extraction target item of the document data P1 and calculates a first confidence level (first accuracy level) of the text information and a second confidence level (second accuracy level) of the image object regarding a confidence level of the extraction target item. In addition, the controller 11 corrects the first confidence level of the text information when the character string rectangle of the text information and the character string rectangle of the image object overlap each other. Then, the controller 11 outputs a candidate character string of the extraction target item based on the corrected first confidence level of the text information. FIG. 3 illustrates an example of the procedure of the character extraction processing.

Note that the disclosure can be understood as a character extraction method in which one or more steps included in the character extraction processing are performed. In addition, one or more steps included in the character extraction processing described herein may be omitted as appropriate. In addition, the respective steps of the character extraction processing may be performed in a different order to the extent that similar effects are obtained. Furthermore, although the example in which the controller 11 of the image processing apparatus 1 executes each step of the character extraction processing has been exemplified and described, in another embodiment, one or more processors may execute each step of the character extraction processing in a distributed manner. In addition, when acquiring document data P1 from each of the plurality of operation terminals 2 (including a scanner), the controller 11 can perform the character extraction processing in parallel for each piece of the document data P1.

In step S1, the controller 11 (the acquisition processing unit 111) acquires document data (a PDF file, an image file, or the like) from the operation terminal 2.

In step S2, the controller 11 determines whether the acquired document data is a file to be processed (for example, a PDF file, an image file, or the like). When the acquired document data is a file to be processed (S2: Yes), the controller 11 shifts the processing to step S3. On the other hand, when the acquired document data is not a file to be processed (S2: No), the controller 11 ends the character extraction processing.

In step S3, the controller 11 determines whether the acquired document data is a PDF file. When the acquired document data is a PDF file (S3: Yes), the controller 11 shifts the processing to step S4. On the other hand, when the acquired document data is not a PDF file, that is, when the acquired document data is an image file (S3: No), the controller 11 shifts the processing to step S5.

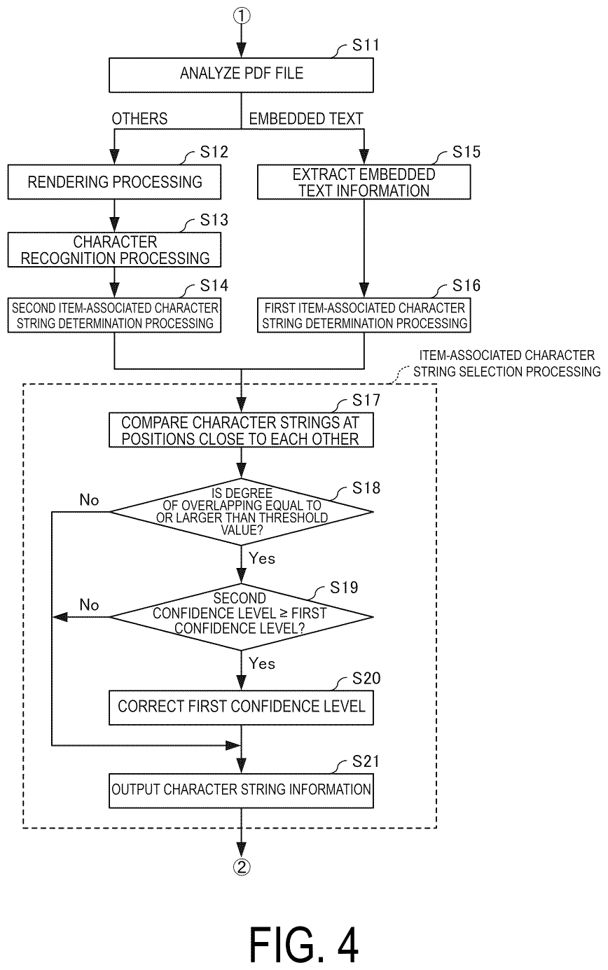

In step S4, the controller 11 determines whether an area occupancy rate (area coverage) of the image object included in the PDF file is equal to or larger than a threshold value. For example, the controller 11 determines whether the image object occupies 95% or more of the entire area of a page of the document data P1 (see FIG. 2). When determining that the area occupancy rate of the image object is equal to or larger than the threshold value (S4: Yes), the controller 11 shifts the processing to step S5. On the other hand, when determining that the area occupancy rate of the image object is less than the threshold value (S4: No), the controller 11 shifts the processing to step S11 (see FIG. 4).

For example, in document data generated by scanning a paper form in an image forming apparatus (such as a scanner), a substantially entire surface of a page is constituted by one image object. It should be noted that text information obtained by character recognition through OCR processing may be embedded in the document data generated by the scanner function. In the document data (PDF file or the like) generated by the scan function, the area occupancy rate of the image object is equal to or larger than the threshold value, and thus the controller 11 shifts the processing to step S5.

In contrast, the document data generated by the document creation application in the operation terminal 2 may be constituted only by character data or may be constituted by character data and an image object. For example, the document data illustrated in FIG. 2 is constituted by character data of embedded text and an image object such as characters and a seal impression. In this case, the area occupancy rate of the image object is less than the threshold value, and thus the controller 11 shifts the processing to step S11.

In step S5, the controller 11 (recognition processing unit 113) performs character recognition processing (OCR pre-processing, OCR processing, OCR post-processing). Specifically, the recognition processing unit 113 performs OCR pre-processing such as vertical orientation correction, skew correction, background removal, and seal impression removal, then recognizes characters (OCR processing), specifies the position and size of a character string rectangle, and after that, performs size adjustment, character correction (OCR post-processing), and the like of the character string rectangle.

In step S6, the controller 11 performs item-associated character string determination processing. Specifically, first, the controller 11 (extraction processing unit 112) extracts a character string of a necessary item (extraction target item). For example, the controller 11 extracts the type of a form, a date, amounts of money (tax-excluded amount/tax-included amount), information about a recipient/an issuer (company names, addresses, telephone numbers, registration numbers), and the like. Next, the controller 11 (calculation processing unit 114) calculates a confidence level (accuracy level) of the characters based on the content of the recognized characters, the positions of the characters, and relationships between the characters and the surrounding characters around the characters. Next, the controller 11 outputs character string information. Specifically, the controller 11 outputs character string information including character information, the positions of characters, the size of a character string rectangle, and the confidence level of the characters.

In step S7, the controller 11 performs item-associated character string selection processing. Specifically, the controller 11 (output processing unit 116) ranks pieces of the character string information according to the confidence levels and sets and outputs the pieces of the character string information in the order of a first candidate, a second candidate, . . . , from the highest rank.

In step S8, the controller 11 (output processing unit 116) causes the extraction result to be displayed. Specifically, the controller 11 displays the pieces of the character string information in the order of candidates and receives a selection operation or the like by a user.

Next, in step S9, the controller 11 (output processing unit 116) outputs the extraction result. Specifically, the controller 11 outputs the selected character string information in a predetermined format in accordance with an instruction from a user.

As described above, when the document data is an image file (S3: No) or when the area occupancy rate of the image object included in the PDF file of the document data is equal to or larger than the threshold value (S4: Yes), the controller 11 performs the OCR processing on the PDF file to extract the character string information of the necessary item. On the other hand, when the area occupancy rate of the image object included in the PDF file of the document data is less than the threshold value (S4: No), the controller 11 performs the following processing.

In step S11, the controller 11 analyzes the PDF file. Specifically, the controller 11 analyzes the PDF file and extracts embedded text and objects other than the embedded text (such as an image object). Note that when the document data is an image file (IMG file), the document data is output as image data as it is, and the embedded text is output as null data.

In step S12, the controller 11 performs rendering processing on the PDF file. Specifically, the controller 11 generates image data for character recognition by imaging the PDF file.

In step S13, the controller 11 performs character recognition processing. Specifically, the controller 11 performs the OCR pre-processing, the OCR processing, and the OCR post-processing described above to recognize the characters and identify the position and size of the character string rectangle. Here, the controller 11 performs the OCR processing on the entire PDF file.

In step S14, the controller 11 performs second item-associated character string determination processing. For example, the controller 11 calculates a confidence level (accuracy level) of characters based on the content of the characters, the positions of the characters, and the relationships between the characters and the surrounding characters around the characters that have been recognized by the OCR processing, regarding the necessary item. Then, the controller 11 outputs character string information including the character information, the positions of the characters, the size of the character string rectangle, and the confidence level of the characters. After step S14, the controller 11 shifts the processing to step S17.

In step S15, the controller 11 extracts embedded text from the PDF file.

In step S16, the controller 11 performs first item-associated character string determination processing. For example, the controller 11 (the calculation processing unit 114) calculates a confidence level (accuracy level) of characters based on the content of the characters of the embedded text, the positions of the characters, and the relationships between the characters and the surrounding characters around the characters, regarding the necessary item. Then, the controller 11 outputs character string information including the character information, the positions of the characters, the size of the character string rectangle, and the confidence level of the characters. After step S16, the controller 11 shifts the processing to step S17.

When acquiring the character string information (S14) that is the character recognition result of the OCR processing and the character string information (S16) of the embedded text, the controller 11 performs the following item-associated character string selection processing (S17 to S21).

In step S17, the controller 11 identifies, among character string rectangles, a first character string rectangle of the embedded text and a second character string rectangle of the characters recognized by the OCR processing that are close to each other. For example, the controller 11 identifies the first character string rectangle and the second character string rectangle that at least partially overlap each other.

In step S18, the controller 11 determines whether the degree of overlapping between the first character string rectangle and the second character string rectangle is equal to or larger than a threshold value. Specifically, the controller 11 determines whether the degree of overlapping (overlapping rate) between the first character string rectangle and the second character string rectangle is 20% or more. When determining that the degree of overlapping is equal to or larger than the threshold value (S18: Yes), the controller 11 shifts the processing to step S19. On the other hand, when determining that the degree of overlapping is less than the threshold value (S18: No), the controller 11 shifts the processing to step S21.

In step S19, the controller 11 compares a first confidence level (first accuracy level) of the embedded text of the first character string rectangle and a second confidence level (second accuracy level) of the recognized characters of the second character string rectangle and determines whether the first confidence level is equal to or lower than the second confidence level. When determining that the first confidence level is equal to or lower than the second confidence level (S19: Yes), the controller 11 shifts the processing to step S20. On the other hand, when determining that the first confidence level is larger than the second confidence level (S19: No), the controller 11 shifts the processing to step S21.

In step S20, the controller 11 (correction processing unit 115) corrects the first confidence level. Specifically, the controller 11 corrects the first confidence level to a value larger than the second confidence level.

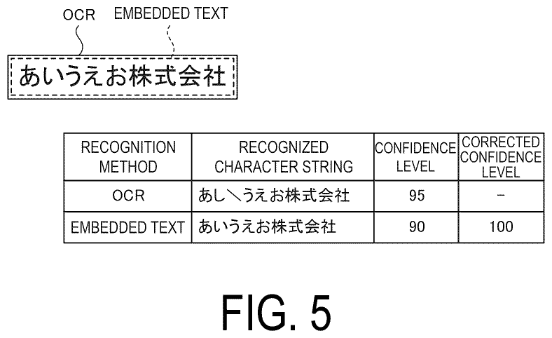

For example, FIG. 5 illustrates a character string recognized by the OCR processing and a character string of the embedded text. In addition, the degree of overlapping of the character string rectangles of the character strings is equal to or larger than 20%. For example, when the calculation processing unit 114 calculates a confidence level (second confidence level) of the characters recognized by the OCR processing as “95” and a confidence level (first confidence level) of the recognized characters of the embedded text as “90”, the correction processing unit 115 corrects the first confidence level to a value of “100” larger than the second confidence level.

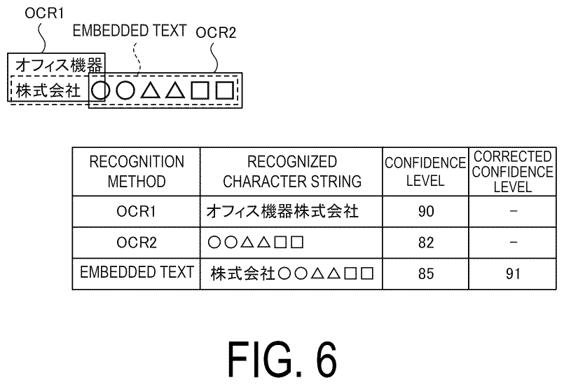

For example, FIG. 6 illustrates character strings (OCR1, OCR2) recognized by the OCR processing and a character string of the embedded text. In addition, the degree of overlapping of the character string rectangles of the character strings is equal to or larger than 20%. For example, when the calculation processing unit 114 calculates a confidence level (second confidence level) of the characters recognized by OCR processing 1 as “90”, a confidence level (second confidence level) of the characters recognized by OCR processing 2 as “82”, and a confidence level (first confidence level) of the recognized characters of the embedded text as “85”, the correction processing unit 115 corrects the first confidence level to a value of “91” that is larger than the second confidence level.

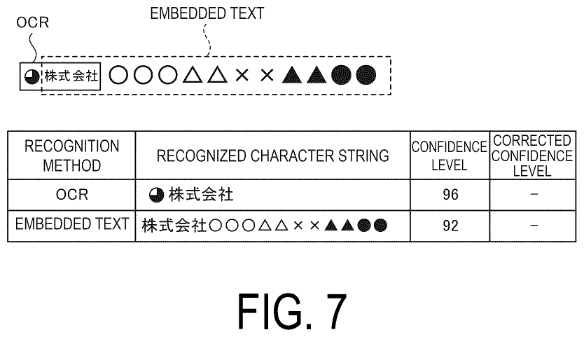

In the example illustrated in FIG. 7, the degree of overlapping of a character string recognized by the OCR processing and a character string of the embedded text is less than 20%. In this case, the correction processing unit 115 does not correct the first confidence level (“96”) and the second confidence level (“92”) calculated by the calculation processing unit 114.

In this manner, the correction processing unit 115 corrects the first confidence level when the degree of overlapping between the first character string rectangle and the second character string rectangle is equal to or larger than the threshold value. Further, the correction processing unit 115 corrects the first confidence level of the embedded text, which is text information, to a value larger than the second confidence level of the character recognition result obtained by the OCR processing performed on the image object. After step S20, the controller 11 shifts the processing to step S21.

In step S21, the controller 11 (output processing unit 116) outputs character string information. Specifically, the controller 11 outputs character string information including character information, the positions of characters, the size of a character string rectangle, and the confidence level of the characters. In addition, the controller 11 ranks pieces of the character string information according to the confidence levels and sets and outputs the pieces of the character string information in the order of a first candidate, a second candidate, . . . , from the highest rank. After step S21, the controller 11 shifts the processing to step S8 (see FIG. 3).

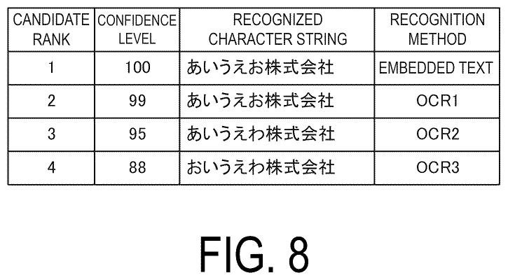

In step S8, the output processing unit 116 displays character string information including a confidence level, a recognized character string, and a recognition method (“embedded text” and “OCR”) in the order of candidate ranks, as illustrated in FIG. 8, for example.

In step S9, the controller 11 (output processing unit 116) receives a selection operation of a user for the pieces of the character string information, and outputs a piece of the character string information selected by the user as an extraction result of the target item.

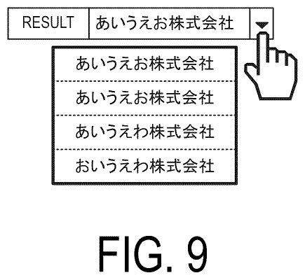

As another embodiment, as illustrated in FIG. 9, the output processing unit 116 may display the recognized character string ranked first in a candidate ranking. Further, the output processing unit 116 may display a pull-down menu and receive an operation of selecting a piece of the character string information from a user.

As described above, every time the controller 11 acquires a document file (the document data P1), the controller 11 performs the character extraction processing.

As described above, the image processing apparatus 1 according to the present embodiment extracts text information and an image object regarding an extraction target item of document data (a document file), calculates a first confidence level of the text information and a second confidence level of the image object regarding a confidence level (accuracy level) of the extraction target item, and corrects the first confidence level when a first character string rectangle of the text information and a second character string rectangle of the image object overlap each other. Then, the image processing apparatus 1 outputs a candidate character string of the extraction target item based on the corrected first confidence level. Specifically, the image processing apparatus 1 corrects the first confidence level when the degree of overlapping between the first character string rectangle and the second character string rectangle is equal to or larger than the threshold value. In addition, when the first confidence level is equal to or lower than the second confidence level, the image processing apparatus 1 corrects the first confidence level to a value higher than the second confidence level. Then, the image processing apparatus 1 outputs the candidate character string based on the corrected first accuracy level and the second accuracy level. For example, the image processing apparatus 1 outputs the text information as the candidate character string.

In this manner, the priority order of the candidate character strings is determined based on the respective confidence levels of the candidate character strings obtained from results of a plurality of different methods (OCR processing and extraction of embedded text) for one extraction target item. For example, the result of the embedded text is preferentially output. Thus, when a garbled candidate character string is included, for example, the priority of the embedded text is corrected to be higher, thereby outputting an appropriate candidate character string. Further, even when an image such as a seal impression is included, the priority of the embedded text is corrected to be higher, thereby outputting an appropriate candidate character string. Thus, according to the above configuration, it is possible to improve the character recognition accuracy of the document data including the text object of the embedded text and the image object.

### Other Embodiments

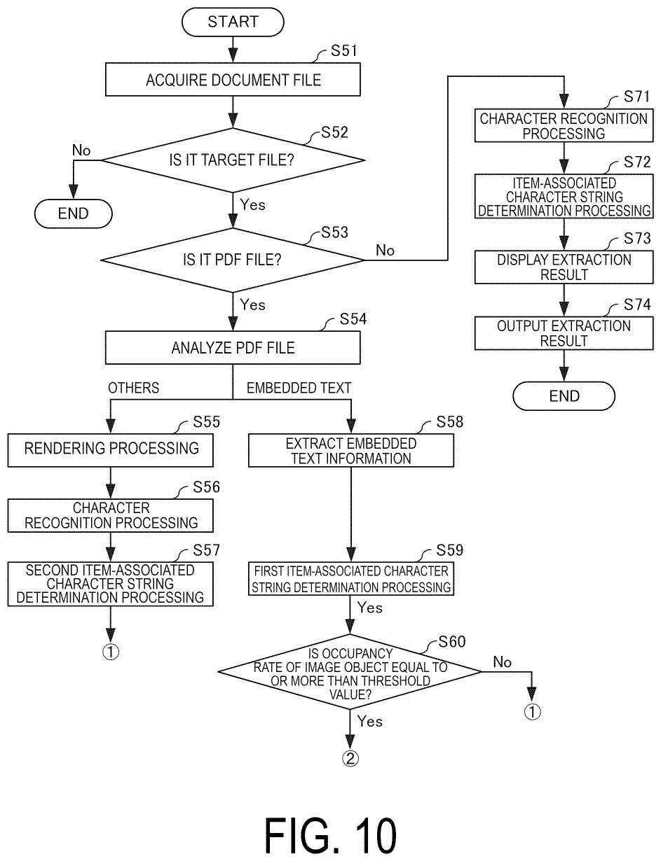

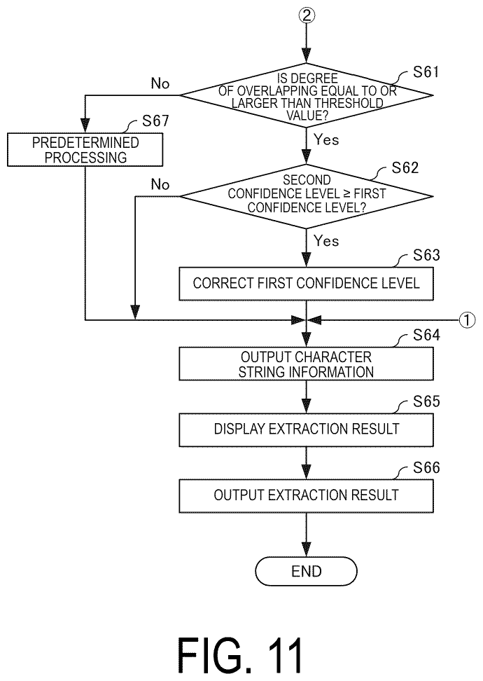

The image processing system 10 of the disclosure is not limited to the embodiment described above and may be implemented as the following embodiment. FIG. 10 and FIG. 11 illustrate another example of the procedure of the character extraction processing. Note that in the following, detailed description of the same processing as the processing illustrated in FIG. 3 and FIG. 4 will be omitted as appropriate.

In step S51, the controller 11 acquires document data (a PDF file, an image file, or the like) from the operation terminal 2.

In step S52, the controller 11 determines whether the acquired document data is document data (for example, a form) to be processed. When the acquired document data is document data to be processed (S52: Yes), the controller 11 shifts the processing to step S53. On the other hand, when the acquired document data is not document data to be processed (S52: No), the controller 11 ends the character extraction processing.

In step S53, the controller 11 determines whether the acquired document data is a PDF file. When the acquired document data is a PDF file (S53: Yes), the controller 11 shifts the processing to step S54. On the other hand, when the acquired document data is not a PDF file, that is, when the acquired document data is an image file (S53: No), the controller 11 shifts the processing to step S71. Processing of steps S71 to S74 is identical to the processing of steps S5, S6, S8, and S9 in FIG. 3.

In step S54, the controller 11 analyzes the PDF file. Specifically, the controller 11 analyzes the PDF file and extracts embedded text and objects other than the embedded text (such as an image object). Note that when the document data is an image file (IMG file), the document data is output as image data as it is, and the embedded text is output as null data.

In step S55, the controller 11 performs rendering processing on the PDF file. Specifically, the controller 11 generates image data for character recognition by imaging the PDF file.

In step S56, the controller 11 performs character recognition processing. Specifically, the controller 11 performs OCR pre-processing, OCR processing, and OCR post-processing to recognize characters and identify the position and size of a character string rectangle.

In step S57, the controller 11 performs second item-associated character string determination processing. For example, the controller 11 calculates a confidence level (accuracy level) of characters based on the content of the characters, the positions of the characters, and the relationships between the characters and the surrounding characters around the characters that have been recognized by the OCR processing, regarding the necessary item. Then, the controller 11 outputs character string information including the character information, the positions of the characters, the size of the character string rectangle, and the confidence level of the characters. After step S57, the controller 11 shifts the processing to step S64 (see FIG. 11).

In step S58, the controller 11 extracts embedded text.

In step S59, the controller 11 performs first item-associated character string determination processing. For example, the controller 11 calculates a confidence level (accuracy level) of characters for the necessary item based on the content of the characters of the embedded text, the positions of the characters, and the relationships between the characters and the surrounding characters of the characters. Then, the controller 11 outputs character string information including the character information, the positions of the characters, the size of the character string rectangle, and the confidence level of the characters. After step S59, the controller 11 shifts the processing to step S60.

In step S60, the controller 11 determines whether the area occupancy rate (area coverage) of the image object included in the PDF file is equal to or higher than a threshold value (for example, 95%). When determining that the area occupancy rate of the image object is equal to or larger than the threshold value (S60: Yes), the controller 11 shifts the processing to step S61 (see FIG. 11). On the other hand, when determining that the area occupancy rate of the image object is less than the threshold value (S60: No), the controller 11 shifts the processing to step S64 (see FIG. 11).

In step S61, the controller 11 determines whether the degree of overlapping between the first character string rectangle and the second character string rectangle is equal to or larger than a threshold value (for example, 20%). When determining that the degree of overlapping is equal to or larger than the threshold value (S61: Yes), the controller 11 shifts the processing to step S62. On the other hand, when determining that the degree of overlapping is less than the threshold value (S61: No), the controller 11 shifts the processing to step S67.

In step S62, the controller 11 compares a first confidence level (first accuracy level) of the embedded text of the first character string rectangle and a second confidence level (second accuracy level) of the recognized characters of the second character string rectangle and determines whether the first confidence level is equal to or lower than the second confidence level. When determining that the first confidence level is equal to or less than the second confidence level (S62: Yes), the controller 11 shifts the processing to step S63. On the other hand, when the controller 11 determines that the first confidence level is larger than the second confidence level (S62: No), the controller 11 shifts the processing to step S64.

In step S63, the controller 11 corrects the first confidence level. Specifically, the controller 11 corrects the first confidence level to a value larger than the second confidence level.

In step S64, the controller 11 outputs character string information. Specifically, the controller 11 outputs character string information including character information, the positions of characters, the size of a character string rectangle, and the confidence level of the characters. In addition, the controller 11 ranks pieces of the character string information according to the confidence levels and sets and outputs the pieces of the character string information in the order of a first candidate, a second candidate, . . . , from the highest rank.

In step S65, the controller 11 displays the character string information including a confidence level, a recognized character string, and a recognition method (“embedded text” and “OCR”) in the order of the candidate ranks.

In step S66, the controller 11 receives a selection operation of a user regarding the character string information, and outputs the character string information selected by the user as an extraction result of the target item.

In step S61, when the degree of overlapping is less than the threshold value (S61: No), the controller 11 performs predetermined processing in step S67. For example, the controller 11 performs any of (1) processing in which the embedded text is not used, (2) processing of keeping the confidence level as it is, and (3) processing of lowering the confidence level. After step S67, the controller 11 shifts the processing to step S64. The controller 11 may perform the character extraction processing in the manner described above.

Note that the controller 11 of the image processing apparatus 1 controls the entire image processing apparatus 1. The controller 11 enables various functions by reading and executing various programs stored in the storage 12 (for example, storage or ROM). The controller 11 may be implemented by one or multiple control devices/arithmetic devices (such as a Central Processing Unit (CPU), a System on a Chip (SoC)). In addition, the controller 11 may include one or multiple control circuits (electronic circuits).

### SUPPLEMENTARY NOTES OF DISCLOSURE

Hereinafter, an outline of the disclosure extracted from the above-described embodiments will be described as supplementary notes. Configurations and processing functions that will be described in the following supplementary notes can be selected and combined as desired.

### Supplementary Note 1

An information processing system including:
an extraction processing circuit that extracts text information and an image object, regarding an extraction target item of document data;
a calculation processing circuit that calculates a first accuracy level of the text information and a second accuracy level of the image object, regarding an accuracy level representing a confidence level of the extraction target item;
a correction processing circuit that corrects the first accuracy level when a first character string rectangle of the text information and a second character string rectangle of the image object overlap each other;
an output processing circuit that outputs a candidate character string of the extraction target item based on the first accuracy level corrected by the correction processing circuit.

### Supplementary Note 2

The information processing system according to Supplementary Note 1, wherein
the correction processing circuit corrects the first accuracy level to a value larger than the second accuracy level when the first accuracy level is equal to or less than the second accuracy level, and
the output processing circuit outputs the candidate character string based on the corrected first accuracy level and the second accuracy level.

### Supplementary Note 3

The information processing system according to Supplementary Note 1 or 2, wherein
the output processing circuit outputs the text information as the candidate character string.

### Supplementary Note 4

The information processing system according to any one of Supplementary Notes 1 to 3, wherein
the correction processing circuit corrects the first accuracy level when a degree of overlapping between the first character string rectangle and the second character string rectangle is equal to or larger than a first threshold value.

### Supplementary Note 5

The information processing system according to any one of Supplementary Notes 1 to 4, wherein
the output processing circuit causes a plurality of the candidate character strings to be displayed side by side in a descending order of a plurality of the accuracy levels corresponding to the plurality of the candidate character strings.

### Supplementary Note 6

The information processing system according to any one of Supplementary Notes 1 to 5, wherein
the correction processing circuit corrects the first accuracy level of embedded text being the text information to a value larger than the second accuracy level of a character recognition result obtained by performing OCR processing on the image object.

### Supplementary Note 7

The information processing system according to any one of Supplementary Notes 1 to 6, wherein
the calculation processing circuit calculates, based on a content of a recognized character, a position of the character and a relationship between the character and a surrounding character around the character, an accuracy level of the character.

### Supplementary Note 8

The information processing system according to any one of Supplementary Notes 1 to 7, wherein
the correction processing circuit corrects the first accuracy level when an area occupancy rate of the image object in the document data is less than a second threshold value.

### Supplementary Note 9

An information processing method executed by one or more processors, the information processing method including:
extracting text information and an image object regarding an extraction target item of document data;
calculating a first accuracy level of the text information and a second accuracy level of the image object, regarding an accuracy level representing a confidence level of the extraction target item;
correcting the first accuracy level when a first character string rectangle of the text information and a second character string rectangle of the image object overlap each other; and
outputting a candidate character string of the extraction target item based on the corrected first accuracy level.

### Supplementary Note 10

A non-transitory computer-readable recording medium recorded with an information processing program that causes one or more processors to execute:
extracting text information and an image object regarding an extraction target item of document data;
calculating a first accuracy level of the text information and a second accuracy level of the image object, regarding an accuracy level representing a confidence level of the extraction target item;
correcting the first accuracy level when a first character string rectangle of the text information and a second character string rectangle of the image object overlap each other; and
outputting a candidate character string of the extraction target item based on the corrected first accuracy level.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system comprising:
one or more processors, wherein
the one or more processors
extract text information and an image object regarding an extraction target item of document data,
calculate a first accuracy level of the text information and a second accuracy level of the image object, regarding an accuracy level representing a confidence level of the extraction target item,
correct the first accuracy level when a first character string rectangle of the text information and a second character string rectangle of the image object overlap each other, and
output a candidate character string of the extraction target item based on the corrected first accuracy level.

2. The information processing system according to claim 1, wherein
the one or more processors
correct the first accuracy level to a value larger than the second accuracy level when the first accuracy level is equal to or less than the second accuracy level, and
output the candidate character string based on the corrected first accuracy level and the second accuracy level.

3. The information processing system according to claim 1, wherein
the one or more processors output the text information as the candidate character string.

4. The information processing system according to claim 1, wherein
the one or more processors correct the first accuracy level when a degree of overlapping between the first character string rectangle and the second character string rectangle is equal to or larger than a first threshold value.

5. The information processing system according to claim 1, wherein
the one or more processors cause a plurality of the candidate character strings to be displayed side by side in a descending order of a plurality of the accuracy levels corresponding to the plurality of the candidate character strings.

6. The information processing system according to claim 1, wherein
the one or more processors correct the first accuracy level of embedded text being the text information to a value larger than the second accuracy level of a character recognition result obtained by performing OCR processing on the image object.

7. The information processing system according to claim 1, wherein
the one or more processors calculate, based on a content of a recognized character, a position of the character and a relationship between the character and a surrounding character around the character, an accuracy level of the character.

8. The information processing system according to claim 1, wherein
the one or more processors correct the first accuracy level when an area occupancy rate of the image object in the document data is less than a second threshold value.

9. An information processing method executed by one or more processors, the information processing method comprising:
extracting text information and an image object regarding an extraction target item of document data;
calculating a first accuracy level of the text information and a second accuracy level of the image object, regarding an accuracy level representing a confidence level of the extraction target item;
correcting the first accuracy level when a first character string rectangle of the text information and a second character string rectangle of the image object overlap each other; and
outputting a candidate character string of the extraction target item based on the corrected first accuracy level.

10. A non-transitory computer-readable recording medium recorded with an information processing program, the information processing program causing one or more processors to execute:
extracting text information and an image object regarding an extraction target item of document data;
calculating a first accuracy level of the text information and a second accuracy level of the image object, regarding an accuracy level representing a confidence level of the extraction target item;
correcting the first accuracy level when a first character string rectangle of the text information and a second character string rectangle of the image object overlap each other; and
outputting a candidate character string of the extraction target item based on the corrected first accuracy level.
